(19) United States
(12) Patent Application Publication
(10) Pub. No.: US 2026/0054232 A1
(43) Pub. Date: Feb. 26, 2026

(54) Effluent Treatment System

(71) Applicant: RKM IP Holding LLC, Dover, DE (US)

(72) Inventor: Roger Kendall McGowan, Buda, TX (US)

(73) Assignee: RKM IP Holding LLC, Dover, DE (US)

(21) Appl. No.: 18/814,962

(22) Filed: Aug. 26, 2024

(51) Int. Cl. B01F 23/232; B01F 23/20; B01F 23/23; B01F 23/231; B03D 1/14

(52) U.S. Cl. CPC B01F 23/2323; B01F 23/23105; B01F 23/2319; B01F 23/29; B03D 1/1431

(57) ABSTRACT

A dispersion for use with an effluent treatment system, and methods of making and using such a dispersion, whereby the dispersion includes a polymer substantially uniformly dispersed within an aqueous solvent. The dispersion can be generated by (i) combining a gas with the polymer and the aqueous solvent, whereby the gas may be effective to disperse the polymer within the aqueous solvent and provide a gas-polymer-aqueous solvent mixture; and (ii) flowing the gas-polymer-aqueous solvent mixture through a mixing chamber comprising static mixing elements disposed therein, whereby the static mixing elements may be effective to further disperse the polymer within the aqueous solvent.

### I. SUMMARY OF THE INVENTION

A broad object of a particular embodiment of the invention can be to provide an inventive dispersion for use with an effluent treatment system, and methods of making and using such a dispersion, whereby the dispersion includes a polymer substantially uniformly dispersed within an aqueous solvent. The dispersion can be generated by (i) combining a gas with the polymer and the aqueous solvent, whereby the gas may be effective to disperse the polymer within the aqueous solvent and provide a gas-polymer-aqueous solvent mixture; and (ii) flowing the gas-polymer-aqueous solvent mixture through a mixing chamber comprising static mixing elements disposed therein, whereby the static mixing elements may be effective to further disperse the polymer within the aqueous solvent.

Another broad object of a particular embodiment of the invention can be to provide a method for removing contaminants from wastewater using the inventive dispersion.

Another broad object of a particular embodiment of the invention can be to provide a method for removing contaminants from wastewater, such as the wastewater from a meat rendering process, using the inventive dispersion.

Another broad object of a particular embodiment of the invention can be to provide a method of treating effluent comprising wastewater containing solids, fats, greases, and/or oils within an aqueous medium, said wastewater generated by agricultural, industrial, sewage, or mining operations, using the inventive dispersion.

Another broad object of a particular embodiment of the invention can be to provide a method of separating effluent into solids, water, and a mixture of fats, oils, and greases using the inventive dispersion.

Another broad object of a particular embodiment of the invention can be to provide a method of recovering tallow from effluent using the inventive dispersion.

Naturally, further objects of the invention are disclosed throughout other areas of the specification, drawings, and claims.

### II. BRIEF DESCRIPTION OF THE DRAWINGS

FIG. 1 is an illustration of a method of using a particular embodiment of the effluent treatment system to recover tallow from effluent.

FIG. 2 is an illustration of a method of making a particular embodiment of the inventive dispersion.

FIG. 3 is an illustration of a method of making a particular embodiment of the inventive dispersion.

FIG. 4 is an illustration of a method of making a particular embodiment of the inventive dispersion.

FIG. 5 is an illustration of a method of using a particular embodiment of the effluent treatment system to recover tallow from effluent.

FIG. 6A is an illustration of a particular embodiment of a static mixer which may be useful for the present invention.

FIG. 6B is an illustration of a particular embodiment of static mixing elements which may be useful for the present invention.

### III. DETAILED DESCRIPTION OF THE INVENTION

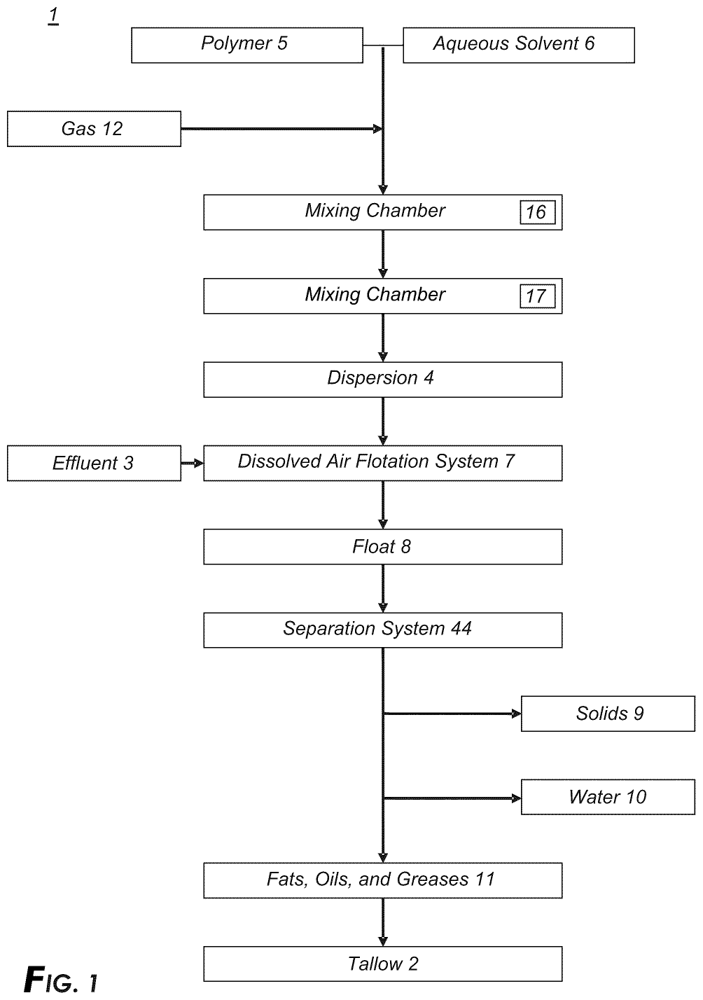

Now referring primarily to FIG. 1, which illustrates a method of using a particular embodiment of the present effluent treatment system (1) to recover tallow (2) from effluent (3), whereby the method generally includes providing an inventive dispersion (4) comprising an amount of polymer (5) (hereinafter simply referred to as “polymer”) substantially uniformly dispersed within an amount of aqueous solvent (6) (hereinafter simply referred to as “aqueous solvent”); combining the dispersion (4) and the effluent (3) (such as within a dissolved air flotation system (7)) to generate a float (8) comprising solids (9), water (10), and a mixture of fats, oils, and greases (11); and separating the solids (9) and the water (10) from the mixture of fats, oils, and greases (11) to provide the tallow (2).

For the purposes of the present invention, the term “effluent” means a flow of matter whereby typically, but not necessarily, the matter includes waste material. As to particular embodiments, effluent may be generated by, as non-limiting examples, agricultural, industrial, sewage, and mining operations. As to particular embodiments, effluent may comprise wastewater, such as wastewater from a meat rendering process which can include contaminants such as solids, sludge, liquid, meat, muscle, fat, bone, blood, or the like.

For the purposes of the present invention, the term “tallow” means a rendered form of lipid material, which can typically be derived from animal tissue. As but a few non-limiting examples, sources of animal tissue can include cattle, pigs, sheep, poultry, seafood, or the like.

For the purposes of the present invention, the term “fats, oils, and greases” means lipid materials, which are typically derived from animal tissue. As to particular embodiments, fats can be generally solid at room temperature whereby oils and greases may be generally liquid at room temperature.

For the purposes of the present invention, the term “solids” means materials other than fats, oils, and greases which can be generally stable in shape and accordingly, may not be fluid in form, such as proteinaceous materials.

For the purposes of the present invention, the term “fluid” or “fluidic” means flowing or flowable; not solid.

For the purposes of the present invention, the term “uniform” means generally not varying or variable.

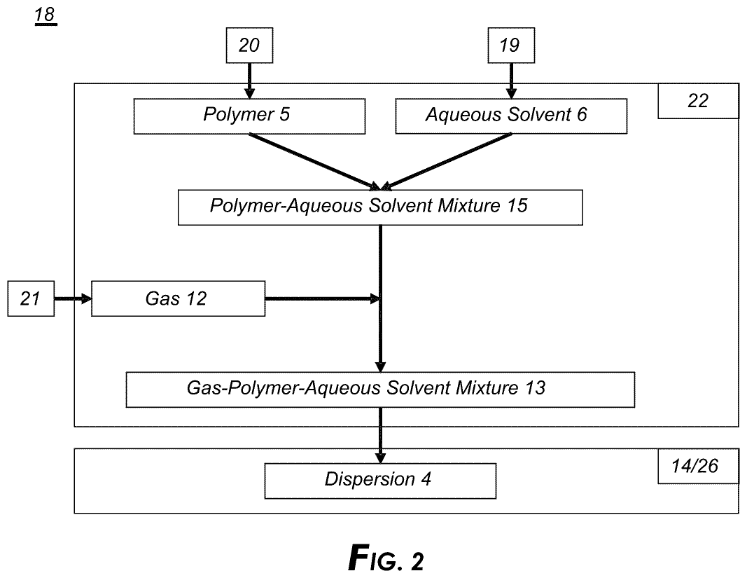

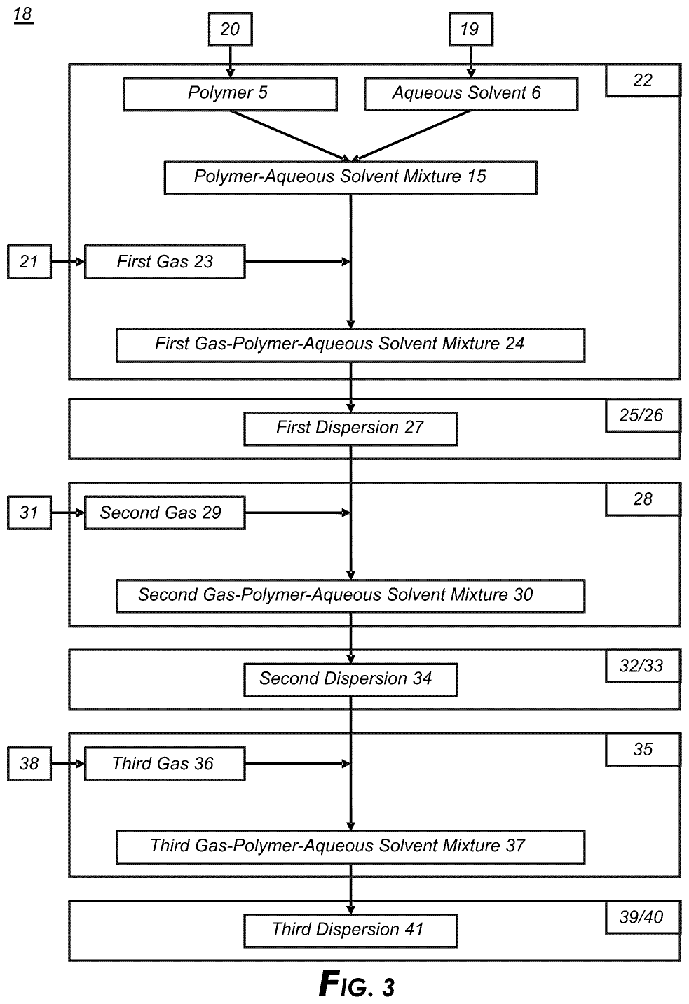

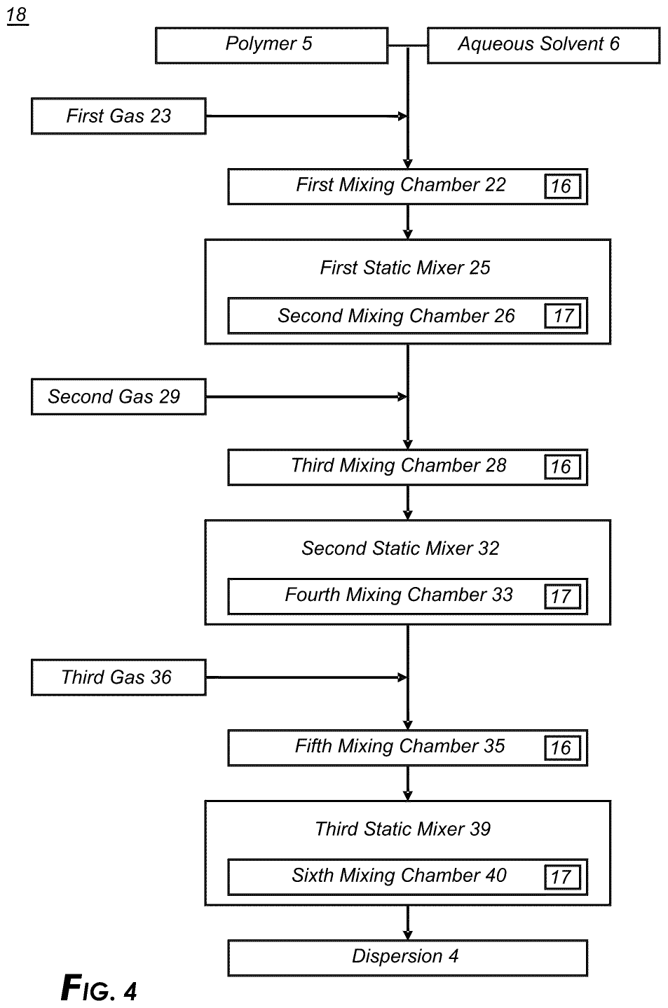

Now referring primarily to FIGS. 2 through 4, the present effluent treatment system (1) utilizes a dispersion (4) to facilitate generation of a float (8) which comprises solids (9), water (10), and a mixture of fats, oils, and greases (11). The dispersion (4) includes a polymer (5) which can be substantially uniformly dispersed within an aqueous solvent (6), whereby the dispersion (4) may be generated by combining an amount of gas (12) (hereinafter simply referred to as “gas”) with the polymer (5) and the aqueous solvent (6) to facilitate dispersion of the polymer (5) within the aqueous solvent (6) and provide a gas-polymer-aqueous solvent mixture (13). Following, the gas-polymer-aqueous solvent mixture (13) can be flowed through a static mixer (14) to further disperse the polymer (5) within the aqueous solvent (6).

The polymer (5) can be comprised of any of a numerous and wide variety of polymeric molecules, each formed from a plurality of subunits bonded together, which upon combination with the effluent (3) (such as in the dissolved air flotation system (7)), may facilitate generation of the float (8) which comprises solids (9), water (10), and a mixture of fats, oils, and greases (11). As but one illustrative example, to generate the float (8), the polymer (5) can facilitate flocculation, agglomeration, coagulation, or the like, or combinations thereof, of components of the float (8).

As non-limiting examples, useful polymers (5) can include solution polymers, such as FLOPAM Product C-311, which may be obtained from SNF, Inc., 1 Chemical Plant Road, P.O. Box 250, Riceboro, Georgia 31323, USA; dispersion polymers, such as ULTIMER® Polymer, which may be obtained from Nalco, 1601 West Diehl Road, Naperville, Illinois 60563, USA; emulsion polymers, such as SEDIFLOC 104CP, which may be obtained from Kemira Chemicals, Inc.; organic coagulants, such as POLYCHEMIE FL2949, which may be obtained from SNF, Inc., 1 Chemical Plant Road, P.O. Box 250, Riceboro, Georgia 31323, USA; and inorganic coagulants, such as ULTRAFLOC® 320HV, which may be obtained from GEO® Specialty Chemicals, 340 Mathers Road, Ambler, Pennsylvania 19002, USA.

As additional non-limiting examples, useful polymers (5) can include those disclosed in U.S. Pat. No. 11,760,665, which is hereby incorporated by reference herein in its entirety. As to particular embodiments, a useful polymer (5) can comprise one or more coagulants. As to other particular embodiments, a useful polymer (5) can comprise one or more flocculants. As to other particular embodiments, a useful polymer (5) can comprise a mixture of one or more coagulants and one or more flocculants which may constitute a coagulant-flocculant mixture.

The polymer (5) can be in any amount which, upon combination with the effluent (3) (such as in the dissolved air flotation system (7)), may facilitate generation of the float (8) comprising solids (9), water (10), and a mixture of fats, oils, and greases (11). As to particular embodiments, the amount of polymer (5) can be tailored to the effluent (3), whereby a lesser or greater amount of polymer (5) may be included in the dispersion (4) based upon the amount of one or more components in the effluent (3) to facilitate generation of the float (8).

As but one illustrative example, polymer (5) can be included in the dispersion (4) in an amount ranging from between about 0.1% to about 50% of the dispersion (4) by weight. As to particular embodiments, the amount of polymer (5) in the dispersion (4) can be selected from the group including or consisting of: between about 0.1% to about 10% of the dispersion (4) by weight; between about 5% to about 15% of the dispersion (4) by weight; between about 10% to about 20% of the dispersion (4) by weight; between about 15% to about 25% of the dispersion (4) by weight; between about 20% to about 30% of the dispersion (4) by weight; between about 25% to about 35% of the dispersion (4) by weight; between about 30% to about 40% of the dispersion (4) by weight; between about 35% to about 45% of the dispersion (4) by weight; and between about 40% to about 50% of the dispersion (4) by weight.

The aqueous solvent (6) (which may be one solvent or a mixture of two or more solvents, depending upon the application) can have any of a numerous and wide variety of formulations and may be in any amount which, upon combining with the polymer (5), can be sufficient to allow substantially uniform dispersion of the polymer (5) therewithin to provide the dispersion (4). As but one illustrative example, the aqueous solvent (6) can be water (10); however; the aqueous solvent (6) need not be limited to water (10). Upon combination, the polymer (5) and the aqueous solvent (6) can provide a polymer-aqueous solvent mixture (15), such as a polymer-water mixture.

As noted above, the dispersion (4) can be generated by combining a gas (12) with the polymer (5) and the aqueous solvent (6) to provide a gas-polymer-aqueous solvent mixture (13), whereby the gas (12) may facilitate substantially uniform dispersion of the polymer (5) within the aqueous solvent (6). As but one illustrative example, the gas (12) can be air; however, the gas (12) need not be limited to air.

The gas (12) can be combined with the polymer (5) and the aqueous solvent (6) by passing the gas (12) through the polymer-aqueous solvent mixture (15), such as by flowing the gas (12) through the polymer-aqueous solvent mixture (15), whereby the gas (12) may take the form of a gas jet and/or gas bubbles (16), depending upon the source of the gas (12) and its parameters.

As to particular embodiments, the gas (12) can be provided in the form of gas bubbles (16), which may generate mixing forces capable of relatively gently mixing the polymer (5) and the aqueous solvent (6) to facilitate substantially uniform dispersion of the polymer (5) within the aqueous solvent (6) to ultimately provide the dispersion (4).

Following, the polymer (5) and the aqueous solvent (6) can be further mixed by a static mixer (14), which may generate mixing forces capable of relatively gently mixing the polymer (5) and the aqueous solvent (6) to facilitate substantially uniform dispersion of the polymer (5) within the aqueous solvent (6) to ultimately provide the dispersion (4).

As to particular embodiments, the mixing forces generated by the gas bubbles (16) and the static mixer (14) can relatively gently mix the polymer (5) and the aqueous solvent (6) to facilitate substantially uniform dispersion of the polymer (5) within the aqueous solvent (6) to provide a substantially homogenous dispersion (4) comprising the polymer (5) and the aqueous solvent (6).

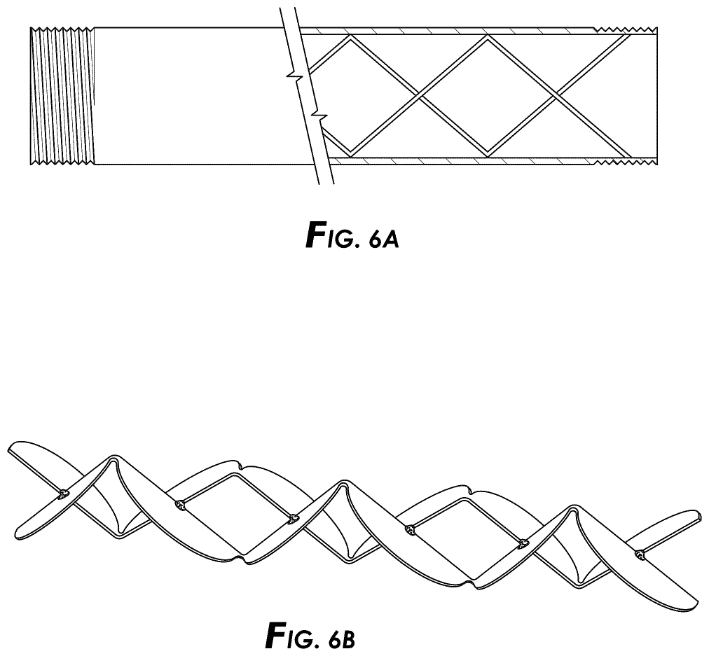

Now referring primarily to FIGS. 6A and 6B, the static mixer (14) can be a device configured to mix the polymer (5) and the aqueous solvent (6) without any moving parts, whereby mixing may be facilitated by internal static mixing elements (17) (which can be configured as baffles, immobile/stationary blades, or the like) disposed within a mixing chamber. The static mixing elements (17) can disrupt the flow of the gas-polymer-aqueous solvent mixture (13) as it passes through the mixing chamber, whereby this disruption creates turbulence which effectively mixes the polymer (5) and the aqueous solvent (6).

For the purposes of the present invention, the term “static” means unmoving and/or motionless and/or immobile and/or stationary and/or fixed.

As but one non-limiting example, a static mixer (14) which may be useful for the present invention can be a Koflo Stainless Steel Static Mixer, such as Model Number 2-40-3-12-2, which may be obtained from Koflo Corporation, 309 Cary Point Drive, Cary, Illinois 60013, USA. This exemplary static mixer (14) includes an inner diameter of about 2 inches, a length of about 33 inches, and 12 static mixing elements (17). Of course, such parameters can vary, depending upon the application.

As to particular embodiments of the dispersion (4), the only mixing forces applied to the polymer (5) and the aqueous solvent (6) to substantially uniformly disperse the polymer (5) within the aqueous solvent (6), thereby providing the dispersion (4), can be the mixing forces generated by the gas bubbles (16) and the static mixer (14). Accordingly, the polymer (5) and the aqueous solvent (6) can be mixed by forces consisting essentially of or consisting of the mixing forces generated by the gas bubbles (16) and the static mixer (14), which are effective to substantially uniformly disperse the polymer (5) within the aqueous solvent (6) to provide the dispersion (4).

The mixing forces generated by the gas bubbles (16) and the static mixer (14) to substantially uniformly disperse the polymer (5) within the aqueous solvent (6), thereby providing the dispersion (4), can be relatively gentle mixing forces such that the polymeric molecules comprising the polymer (5) remain generally intact or are not damaged by the application of the mixing forces. For example, following the application of the mixing forces generated by the gas bubbles (16) and the static mixer (14), the molecular weight of the polymeric molecules can remain substantially unchanged.

As to particular embodiments, the molecular weight of a percentage of the polymeric molecules which comprise the polymer (5) can remain substantially unchanged following the application of the mixing forces generated by the gas bubbles (16) and the static mixer (14), whereby the percentage may be selected from the group including or consisting of: about 100% of the polymeric molecules; greater than about 99% of the polymeric molecules; greater than about 95% of the polymeric molecules; greater than about 90% of the polymeric molecules; greater than about 80% of the polymeric molecules; greater than about 70% of the polymeric molecules; greater than about 60% of the polymeric molecules; and greater than about 50% of the polymeric molecules. Thus, the mixing forces generated by the gas bubbles (16) and the static mixer (14) can be considered non-shearing mixing forces, which, upon application, do not shear a majority of the polymeric molecules comprising the polymer (5).

Said another way, in the present invention, the polymer (5) may not be subject to shear conditions or shearing forces for substantially uniform dispersion of the polymer (5) within the aqueous solvent (6), which may be in contrast to conventional methods of mixing polymer (5) and solvent, whereby shearing forces and in particular, high shearing forces, can typically be applied to disperse the polymer (5) within the solvent. As but one illustrative example, conventional methods of mixing polymer (5) and solvent may utilize an impeller including a plurality of moving blades to generate high shear conditions to disperse the polymer (5) within the solvent.

Concisely, a method of making the inventive dispersion (4) for use with an effluent treatment system (1) includes combining a polymer (5) with an aqueous solvent (6) to provide a polymer-aqueous solvent mixture (15). Next, the method includes combining a gas (12) with the polymer-aqueous solvent mixture (15) to disperse the polymer (5) within the aqueous solvent (6) and provide a gas-polymer-aqueous solvent mixture (13). Next, the method includes flowing the gas-polymer-aqueous solvent mixture (13) through a static mixer (14) to further disperse the polymer (5) within the aqueous solvent (6) and provide the inventive dispersion (4).

Now referring primarily to FIGS. 2 through 4, the inventive dispersion (4) can be generated in a dispersion generator (18) through which fluid may flow. The dispersion generator (18) can include an aqueous solvent source (19), a polymer source (20), and a first gas source (21) in fluidic communication with a first mixing chamber (22) for ingress thereinto via corresponding inlets. The polymer (5) can be provided in fluid form for ingress into the first mixing chamber (22), for example as a fluidic polymer solution, a fluidic polymer suspension, a fluidic polymer emulsion, or combinations thereof. Correspondingly, the polymer (5) can be introduced from the polymer source (20) (such as via injection) into an aqueous solvent (6) as the aqueous solvent (6) flows through the first mixing chamber (22), which may be provided by a conduit.

As to particular embodiments, the first gas source (21) can be downstream of the aqueous solvent source (19) and the polymer source (20) such that the polymer (5) may firstly be combined with the aqueous solvent (6) within the first mixing chamber (22) to provide a fluid flow of the polymer-aqueous solvent mixture (15).

Subsequent to generation of the polymer-aqueous solvent mixture (15), a first gas (23) (provided by an atmospheric gas source (i.e., the atmosphere or ambient environment), a pressurized gas source, or the like, or combinations thereof) can be introduced into the first mixing chamber (22) for combination with the polymer-aqueous solvent mixture (15) to disperse the polymer (5) within the aqueous solvent (6) and provide a first gas-polymer-aqueous solvent mixture (24).

Following, the first gas-polymer-aqueous solvent mixture (24) can flow through a first mixing chamber outlet and into a fluidically coupled first static mixer (25) via a first static mixer inlet, whereby the first static mixer (25) (which may be a component of the dispersion generator (18)) includes a second mixing chamber (26) with flow-disrupting static mixing elements (17) disposed therein. In the second mixing chamber (26), the polymer (5) can be further dispersed within the aqueous solvent (6) to provide a first dispersion (27). Of note, the aqueous solvent (6), the polymer (5), and the first gas (23) combine in the first mixing chamber (22) prior to ingress into the second mixing chamber (26).

As to particular embodiments, the first dispersion (27) generated by combining the aqueous solvent (6), the polymer (5), and the first gas (23) in the first and second mixing chambers (22)(26) can egress from the second mixing chamber (26) for combination with effluent (3), such as within a dissolved air flotation system (7), to generate the float (8) comprising solids (9), water (10), and a mixture of fats, oils, and greases (11).

As to other particular embodiments, following egression from the second mixing chamber (26) via a second mixing chamber outlet, the first dispersion (27) can ingress into a fluidically coupled third mixing chamber (28) via a third mixing chamber inlet, whereby the third mixing chamber (28) (which may be a component of the dispersion generator (18)) may be provided by a conduit. A second gas (29) can be introduced into the third mixing chamber (28) for combination with the first dispersion (27) to further disperse the polymer (5) within the aqueous solvent (6) and provide a second gas-polymer-aqueous solvent mixture (30).

The third mixing chamber (28) can be the same as or different from the first mixing chamber (22), depending upon the embodiment. Additionally, the flow rate through the third mixing chamber (28) can be the same as or different from the flow rate through the first mixing chamber (22), depending upon the embodiment.

The second gas (29) can be provided by a second gas source (31) in fluidic communication with the third mixing chamber (28) for ingress therein via a corresponding inlet. The second gas (29) (provided by an atmospheric gas source (i.e., the atmosphere or ambient environment), a pressurized gas source, or the like, or combinations thereof) can be the same as or different from the first gas (23), depending upon the embodiment. Further, the second gas source (31) can be the same as or different from the first gas source (21), depending upon the embodiment. Moreover, the flow rate of the second gas (29) can be the same as or different from the flow rate of the first gas (23), depending upon the embodiment.

Following generation, the second gas-polymer-aqueous solvent mixture (30) can flow through a third mixing chamber outlet and into a fluidically coupled second static mixer (32) via a second static mixer inlet, whereby the second static mixer (32) (which may be a component of the dispersion generator (18)) includes a fourth mixing chamber (33) with flow-disrupting static mixing elements (17) disposed therein. In the fourth mixing chamber (33), the polymer (5) can be further dispersed within the aqueous solvent (6) to provide a second dispersion (34). Of note, the first dispersion (27) and the second gas (29) combine in the third mixing chamber (28) prior to ingress into the fourth mixing chamber (33).

The second static mixer (32) can be the same as or different from the first static mixer (25), depending upon the embodiment. Also, the fourth mixing chamber (33) can be the same as or different from the second mixing chamber (26), depending upon the embodiment. In addition, the flow rate through the fourth mixing chamber (33) can be the same as or different from the flow rate through the second mixing chamber (26), depending upon the embodiment.

As to particular embodiments, the second dispersion (34) generated by combining the first dispersion (27) and the second gas (29) in the third and fourth mixing chambers (28)(33) can egress from the fourth mixing chamber (33) for combination with effluent (3), such as within a dissolved air flotation system (7), to generate the float (8) comprising solids (9), water (10), and a mixture of fats, oils, and greases (11).

As to other particular embodiments, following egression from the fourth mixing chamber (33) via a fourth mixing chamber outlet, the second dispersion (34) can ingress into a fluidically coupled fifth mixing chamber (35) via a fifth mixing chamber inlet, whereby the fifth mixing chamber (35) (which may be a component of the dispersion generator (18)) may be provided by a conduit. A third gas (36) can be introduced into the fifth mixing chamber (35) for combination with the second dispersion (34) to further disperse the polymer (5) within the aqueous solvent (6) and provide a third gas-polymer-aqueous solvent mixture (37).

The fifth mixing chamber (35) can be the same as or different from the first mixing chamber (22) and/or the third mixing chamber (28), depending upon the embodiment. Additionally, the flow rate through the fifth mixing chamber (35) can be the same as or different from the flow rate through the first mixing chamber (22) and/or the third mixing chamber (28), depending upon the embodiment.

The third gas (36) can be provided by a third gas source (38) in fluidic communication with the fifth mixing chamber (35) for ingress therein via a corresponding inlet. The third gas (36) (provided by an atmospheric gas source (i.e., the atmosphere or ambient environment), a pressurized gas source, or the like, or combinations thereof) can be the same as or different from the first gas (23) and/or the second gas (29), depending upon the embodiment. Further, the third gas source (38) can be the same as or different from the first gas source (21) and/or the second gas source (31), depending upon the embodiment. Moreover, the flow rate of the third gas (36) can be the same as or different from the flow rate of the first gas (23) and/or the second gas (29), depending upon the embodiment.

Following generation, the third gas-polymer-aqueous solvent mixture (37) can flow through a fifth mixing chamber outlet and into a fluidically coupled third static mixer (39) via a third static mixer inlet, whereby the third static mixer (39) (which may be a component of the dispersion generator (18)) includes a sixth mixing chamber (40) with flow-disrupting static mixing elements (17) disposed therein. In the sixth mixing chamber (40), the polymer (5) can be further dispersed within the aqueous solvent (6) to provide a third dispersion (41). Of note, the second dispersion (34) and the third gas (36) combine in the fifth mixing chamber (35) prior to ingress into the sixth mixing chamber (40).

The third static mixer (39) can be the same as or different from the first static mixer (25) and/or the second static mixer (32), depending upon the embodiment. Also, the sixth mixing chamber (40) can be the same as or different from the second mixing chamber (26) and/or the fourth mixing chamber (33), depending upon the embodiment. In addition, the flow rate through the sixth mixing chamber (40) can be the same as or different from the flow rate through the second mixing chamber (26) and/or the fourth mixing chamber (33), depending upon the embodiment.

As to particular embodiments, the third dispersion (41) generated by combining the second dispersion (34) and the third gas (36) in the fifth and sixth mixing chambers (35)(40) can egress from the sixth mixing chamber (40) for combination with effluent (3), such as within a dissolved air flotation system (7), to generate the float (8) comprising solids (9), water (10), and a mixture of fats, oils, and greases (11).

As to particular embodiments, the above-detailed process can be repeated one or more additional times, depending upon the application.

As to particular embodiments, the dispersion generator (18) can further include one or more valves having locations and functions within the system as would be supposed by one of ordinary skill in the art.

As to particular embodiments, the dispersion generator (18) can further include one or more adjustment elements having locations and functions within the system as would be supposed by one of ordinary skill in the art. As but one illustrative example, a pressure adjustment element can be communicatively coupled to one or more gas sources (21)(31)(38) and may be effective to control the pressure of the corresponding flow of gas (23)(29)(36).

Similarly, as to particular embodiments, the dispersion generator (18) can further include one or more sensors having locations and functions within the system as would be supposed by one of ordinary skill in the art. As but one illustrative example, a pressure sensor can be operatively coupled to one or more gas sources (21)(31)(38), whereby the pressure sensor may monitor the pressure of the corresponding flow of gas (23)(29)(36).

As to particular embodiments, the dispersion generator (18) can further include a process controller, which may be configured for manual or automated control of one or more components of the dispersion generator (18). As to particular embodiments, the process controller can include a display configured for displaying any of a numerous and wide variety of process parameters.

As to particular embodiments, the first dispersion (27) can comprise a polymer (5) substantially uniformly dispersed within an aqueous solvent (6).

As to particular embodiments, the second dispersion (34) can comprise a polymer (5) substantially uniformly dispersed within an aqueous solvent (6).

As to particular embodiments, the third dispersion (41) can comprise a polymer (5) substantially uniformly dispersed within an aqueous solvent (6).

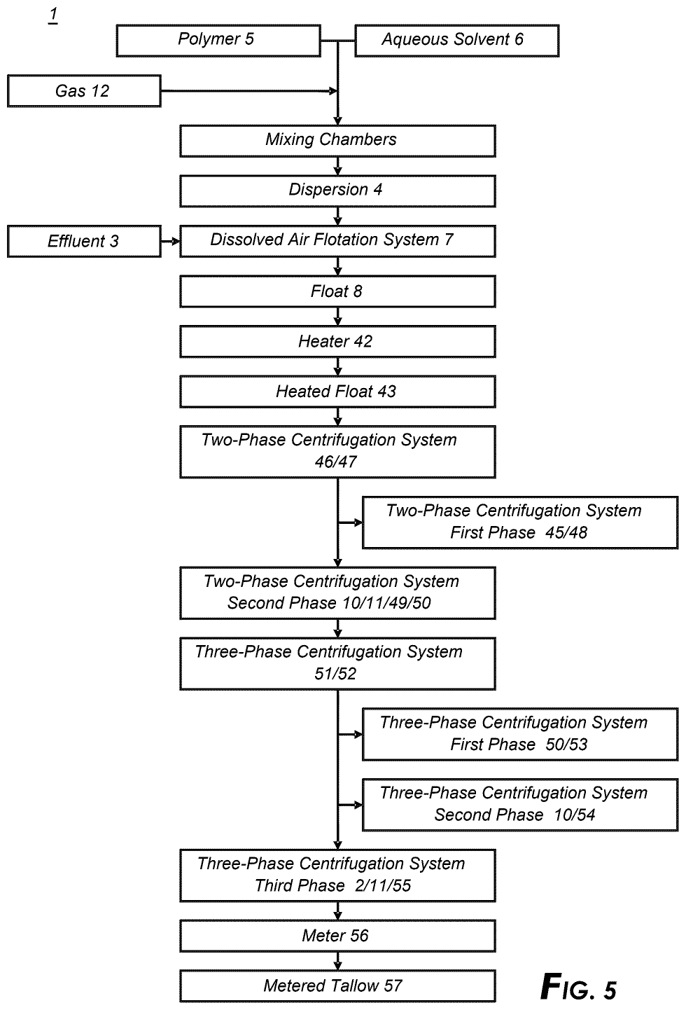

Now referring primarily to FIGS. 1 and 5, the dispersion (4) can be combined with effluent (3), such as within a dissolved air flotation system (7), to generate a float (8) comprising solids (9), water (10), and a mixture of fats, oils, and greases (11), whereby one of ordinary skill in the art would be familiar with the conventional means by which the float (8) may be generated within the dissolved air flotation system (7). Subsequently, the float (8) can be collected, again by conventional means.

As to particular embodiments, a heater (42) can be in fluidic communication with the dissolved air flotation system (7). Via the heater (42), the float (8) can be heated to provide a heated float (43) which may be capable of fluidic movement or flowing. As but one illustrative example, the float (8) can be pumped, for example via a rotary lobe pump, to a heater (42), for example a steam heat exchanger, which may heat the float (8) to provide the heated float (43), whereby the temperature provided by the heater (42) may be any temperature which facilitates fluidic movement or flowing of the heated float (43). As a non-limiting example, the heater (42) can provide a temperature greater than about 90 degrees Celsius (° C.), which may render the heated float (43) fluidic.

Following, a separation system (44) can be in fluidic communication with the heater (42). Via the separation system (44), the float (8) can be subject to separation whereby the solids (9) and water (10) may be separated from the mixture of fats, oils, and greases (11) to provide tallow (2).

Again referring primarily to FIGS. 1 and 5, as to particular embodiments, the float (8) can be subject to separation whereby a first amount of solids (45) may be separated from the water (10) and the mixture of fats, oils, and greases (11). As but one illustrative example, the float (8) can be separated by a first centrifugation system (46), which may, but need not necessarily, include a decanter centrifuge such as a Sharples P3400 Decanter Centrifuge, as a non-limiting example. As to particular embodiments, the decanter centrifuge can, but need not necessarily, include a variable-speed drive.

As to particular embodiments, the decanter centrifuge can, but need not necessarily, further include a composite/carbide-tipped conveyor, which may be in contrast to conventional stainless steel or carbon steel conveyors. As but one non-limiting example, the composite can be epoxy, thereby providing an epoxy/carbide-tipped conveyor.

As to particular embodiments, the first centrifugation system (46) can be a two-phase centrifugation system (47) in which a first amount of solids (45) may be separated from a second amount of solids (50), the water (10), and the mixture of fats, oils, and greases (11); thus, the two-phase centrifugation system (47) can generate a two-phase centrifugation system first phase (48) comprising or consisting of a first amount of solids (45) and a two-phase centrifugation system second phase (49) comprising or consisting of a second amount of solids (50), the water (10), and the mixture of fats, oils, and greases (11).

As to particular embodiments having a first centrifugation system (46) configured as a decanter centrifuge including a composite/carbide-tipped conveyor, the two-phase centrifugation system second phase (49) can have a greater volume than comparable phases generated upon centrifugation with a conventional three-phase centrifuge, typically including a stainless steel or carbon steel conveyor. Accordingly, the two-phase centrifugation system first phase (48) can have a lesser amount of fluid, also in comparison to a comparable phase generated upon centrifugation with a conventional three-phase centrifuge.

Following generation by the two-phase centrifugation system (47), the two-phase centrifugation system second phase (49) can then be subject to separation whereby the second amount of solids (50) and the water (10) may be separated from the mixture of fats, oils, and greases (11) to provide tallow (2). As but one illustrative example, the two-phase centrifugation system second phase (49) can be separated by a second centrifugation system (51), which may, but need not necessarily, include a disk stack centrifuge such as Westfalia SA-40-03-177 Disc Centrifuge, as a non-limiting example.

As to particular embodiments, the second centrifugation system (51) can be a three-phase centrifugation system (52) in which the second amount of solids (50) and the water (10) may be separated from the mixture of fats, oils, and greases (11); thus, the three-phase centrifugation system (52) can generate a three-phase centrifugation system first phase (53) comprising or consisting of the second amount of solids (50), a three-phase centrifugation system second phase (54) comprising or consisting of the water (10), and a three-phase centrifugation system third phase (55) comprising or consisting of the mixture of fats, oils, and greases (11) which provide tallow (2).

As to particular embodiments, following recovery of the tallow (2) from the effluent (3), the tallow (2) can then be subject to metering by a meter (56) to provide metered tallow (57).

The quality of the tallow (2) recovered from effluent (3) using the present effluent treatment system (1) can correspond to the specifications contained in Rule 7 of the Rules of the American Fats and Oils Association for the Animal Tallow and Grease—(Domestic Contract), whereby the Standard Grade Specification and Quality Tolerances for Tallows and Greases are set forth in Table 1 as follows:

TABLE 1

| | Titer | F.F.A. | F.A.C. | R&B Color | M.I.U. |
|---|---|---|---|---|---|
| Grade | Minimum | Maximum | Maximum | Maximum | Maximum |
| Edible Tallow | 41.0 | 0.75 | 3 | none | * |
| Lard (Edible) | 38.0 | 0.50 | ** | none | * |
| Top White Tallow | 41.0 | 2 | 5 | 0.5 | 1 |
| All Beef Packer | 42.0 | 2 | none | 0.5 | 1 |
| Tallow | | | | | |
| Extra Fancy Tallow | 41.0 | 3 | 5 | none | 1 |
| Fancy Tallow | 40.5 | 4 | 7 | none | 1 |
| Bleachable Fancy | 40.5 | 4 | none | 1.5 | 1 |
| Tallow | | | | | |
| Prime Tallow | 40.5 | 6 | 13-11B | none | 1 |
| Special Tallow | 40.0 | 10 | 21 | none | 1 |
| No. 2 Tallow | 40.0 | 35 | none | none | 2 |
| “A” Tallow | 39.0 | 15 | 39 | none | 2 |
| Choice White | 36.0 | 4 | 13-11B | none | 1 |
| Grease | | | | | |
| Yellow Grease | *** | **** | 39 | none | 2 |

Titer: The titer determines the solidification point of fatty acids; reported in degrees Celsius (° C.).
F.F.A.: Stands for free fatty acids; reported in percentage of oleic acid.
F.A.C.: Stands for Fat Analysis Committee, which is a method that determines the color of fats and oils by comparison with AOCS FAC color standards.
R&B Color: Stands for refining and bleaching color, which is the color after refining and bleaching; reported in terms of red on a 5 ¼ inch cell or tube of AOCS methods.
M.E.K.: a peroxide value expressed in milli equivalents per kilo; measure of fat oxidation.
M.I.U.: group of tests including (M) moisture and volatile matter, (I) insoluble impurities, and (U) unsaponifiable matter; reported as percentages; measure of the amount of non-fatty matter present.
* Moisture maximum 0.20%. Insoluble impurities maximum 0.05%.
** Lovibond Color 5 ¼ inch cell - Max. 1.5 Red. Lard Peroxide Value 4.0 M.E.K. Max.
*** Titer minimum, when required, to be negotiated between buyer and seller on a contract by contract basis.
**** F.F.A. maximum, when required, to be negotiated between buyer and seller on a contract by contract basis.

As to particular embodiments, the quality tolerances of the tallow (2) recovered from effluent (3) using the present effluent treatment system (1) can correspond to the quality tolerances of one or more tallows or greases specified in Table 1.

As to particular embodiments, the quality tolerances of the tallow (2) recovered from effluent (3) using the present effluent treatment system (1) can correspond to the quality tolerances of Inedible Bleachable Packer Tallow, which includes a titer minimum of at least about 40-42 degrees Celsius, a F.F.A. maximum of less than about 5%, and an M.I.U. maximum of less than about 1%.

Of note, while the inventive dispersion (4) has been herein described in conjunction with the present effluent treatment system (1), its use need not be limited thereto, as the inventive dispersion (4) may be used for a numerous and wide variety of applications.

As can be easily understood from the foregoing, the basic concepts of the present invention may be embodied in a variety of ways. The invention involves numerous and varied embodiments of an effluent treatment system and methods for making and using such an effluent treatment system.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “mixture” should be understood to encompass disclosure of the act of “mixing”—whether explicitly discussed or not—and, conversely, were there effectively disclosure of the act of “mixing”, such a disclosure should be understood to encompass disclosure of a “mixture” and even a “means for mixing”. Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the effluent treatment systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. A dispersion for use with an effluent treatment system, said dispersion comprising:
a polymer substantially uniformly dispersed within an aqueous solvent;
wherein said dispersion is generated by a method comprising:
combining a gas with said polymer and said aqueous solvent, said gas effective to disperse said polymer within said aqueous solvent and provide a gas-polymer-aqueous solvent mixture; and
flowing said gas-polymer-aqueous solvent mixture through a mixing chamber comprising static mixing elements disposed therein, said static mixing elements effective to further disperse said polymer within said aqueous solvent.

2. The dispersion of claim 1, wherein said gas and said static mixing elements are effective to substantially uniformly disperse said polymer within said aqueous solvent.

3. The dispersion of claim 1, wherein an amount of said polymer is in a range of between about 0.1% to about 50% of said dispersion by weight.

4. The dispersion of claim 1, wherein said aqueous solvent comprises water.

5. The dispersion of claim 1, wherein said gas comprises air.

6. The dispersion of claim 1, wherein said gas is in the form of gas bubbles.

7. The dispersion of claim 6, wherein said gas bubbles and said static mixing elements generate mixing forces which relatively gently mix said polymer and said aqueous solvent to substantially uniformly disperse said polymer within said aqueous solvent to provide said dispersion.

8. The dispersion of claim 7, wherein said dispersion comprising said polymer and said aqueous solvent is substantially homogenous.

9. The dispersion of claim 7, wherein said polymer and said aqueous solvent are mixed by forces consisting essentially of said mixing forces generated by said gas bubbles and said static mixing elements.

10. The dispersion of claim 7, wherein said polymer and said aqueous solvent are mixed by forces consisting of said mixing forces generated by said gas bubbles and said static mixing elements.

11. The dispersion of claim 7, wherein said polymer and said aqueous solvent are mixed by only said mixing forces generated by said gas bubbles and said static mixing elements.

12. The dispersion of claim 7, wherein upon application of said mixing forces generated by said gas bubbles and said static mixing elements, the molecular weight of polymeric molecules which comprise said polymer remains substantially unchanged.

13. The dispersion of claim 7, wherein said mixing forces generated by said gas bubbles and said static mixing elements comprise non-shearing mixing forces.

14. The dispersion of claim 1, wherein said method further comprises:
firstly combining said polymer and said aqueous solvent to provide a polymer-aqueous solvent mixture;
subsequently combining said gas with said polymer-aqueous solvent mixture, said gas effective to disperse said polymer within said aqueous solvent and provide said gas-polymer-aqueous solvent mixture; and
subsequently flowing said gas-polymer-aqueous solvent mixture through said mixing chamber comprising said static mixing elements disposed therein, said static mixing elements effective to further disperse said polymer within said aqueous solvent.

15. The dispersion of claim 1, wherein said method further comprises:
firstly combining said polymer and said aqueous solvent in a first mixing chamber to provide a polymer-aqueous solvent mixture;
subsequently combining a first gas with said polymer-aqueous solvent mixture in said first mixing chamber, said first gas effective to disperse said polymer within said aqueous solvent and provide a first gas-polymer-aqueous solvent mixture; and
subsequently flowing said first gas-polymer-aqueous solvent mixture through a second mixing chamber comprising second mixing chamber static mixing elements disposed therein, said second mixing chamber static mixing elements effective to further disperse said polymer within said aqueous solvent to provide a first dispersion.

16. The dispersion of claim 15, wherein said method further comprises:
subsequently combining a second gas with said first dispersion in a third mixing chamber, said second gas effective to further disperse said polymer within said aqueous solvent and provide a second gas-polymer-aqueous solvent mixture; and
subsequently flowing said second gas-polymer-aqueous solvent mixture through a fourth mixing chamber comprising fourth mixing chamber static mixing elements disposed therein, said fourth mixing chamber static mixing elements effective to further disperse said polymer within said aqueous solvent to provide a second dispersion.

17. The dispersion of claim 16, wherein said method further comprises:
subsequently combining a third gas with said second dispersion in a fifth mixing chamber, said third gas effective to further disperse said polymer within said aqueous solvent and provide a third gas-polymer-aqueous solvent mixture; and
subsequently flowing said third gas-polymer-aqueous solvent mixture through a sixth mixing chamber comprising sixth mixing chamber static mixing elements disposed therein, said sixth mixing chamber static mixing elements effective to further disperse said polymer within said aqueous solvent to provide a third dispersion in which said polymer is substantially uniformly dispersed within said aqueous solvent.

18. The dispersion of claim 17, wherein said method further comprises combining said third dispersion with an effluent to generate a float comprising tallow.

19. The dispersion of claim 18, wherein said method further comprises generating said float via a dissolved air flotation system.

20. The dispersion of claim 18, wherein said method further comprises recovering said tallow from said float.

21-50. (canceled)
